(19) United States
(12) Patent Application Publication
(10) Pub. No.: US 2024/0097179 A1
(43) Pub. Date: Mar. 21, 2024

(54) ENERGY STORAGE DEVICE

(71) Applicant: GS Yuasa International Ltd., Kyoto (JP)

(72) Inventors: Kazuya OKABE, Kyoto (JP); Ryoichi OKUYAMA, Kyoto (JP)

(73) Assignee: GS Yuasa International Ltd., Kyoto (JP)

(21) Appl. No.: 18/274,211

(22) PCT Filed: Jan. 25, 2022
(86) PCT No.: PCT/JP2022/002617

§ 371 Date: Jul. 25, 2023

(30) Foreign Application Priority Data
Jan. 29, 2021 (JP) 2021-012843

(51) Int. Cl. H01M 10/0525; H01M 10/0587; H01M 50/103; H01M 50/531

(52) U.S. Cl. CPC H01M 10/0525; H01M 10/0587; H01M 50/103; H01M 50/531

(57) ABSTRACT

An energy storage device includes: an electrode assembly formed by winding a plurality of plates; and a case housing the electrode assembly. The electrode assembly includes: a body including a flat portion and a pair of curved portions sandwiching the flat portion; and a plurality of tabs, each tab formed by stacking a plurality of pieces of plates with the same polarity out of the plurality of plates, and protrude as a pair from each of both end faces of the body in a winding-axis direction. At least one tab of the plurality of tabs includes a bent portion continuous with the curved portion, and a pair of extended portions extended from the bent portion and continuous with the flat portion.

### TECHNICAL FIELD

The present invention relates to an energy storage device including an electrode assembly.

### BACKGROUND ART

Conventionally, there has been known an energy storage device with a case housing an electrode assembly formed by winding plates (e.g., see Patent Document 1).

### PRIOR ART DOCUMENT

### Patent Document

Patent Document 1: JP-A-2010-73580

### SUMMARY OF THE INVENTION

### Problems to be Solved by the Invention

Meanwhile, for example, when the energy storage device is subjected to an impact or the like, the electrode assembly within the case may vibrate and be damaged.

An object of the present invention is to provide an energy storage device capable of preventing damage to an electrode assembly.

### Means for Solving the Problems

An energy storage device according to one aspect of the present invention is an energy storage device provided with: an electrode assembly formed by winding a plurality of plates; and a case configured to house the electrode assembly. The electrode assembly includes a body including a flat portion and a pair of curved portions sandwiching the flat portion, and a plurality of tabs, each tab formed by stacking a plurality of pieces of plates with the same polarity out of the plurality of plates, the plurality of tabs protruding as a pair from each of both end faces of the body in a winding-axis direction. At least one tab of the plurality of tabs includes a bent portion continuous with the curved portion and a pair of extended portions extended from the bent portion and continuous with the flat portion.

### Advantages of the Invention

According to the present invention, it is possible to provide an energy storage device capable of preventing damage to an electrode assembly.

### BRIEF DESCRIPTION OF THE DRAWINGS

FIG. 1 is a perspective view illustrating an appearance of an energy storage device according to an embodiment.

FIG. 2 is an exploded perspective view illustrating each component of the energy storage device according to the embodiment in an exploded state.

FIG. 3 is a perspective view illustrating a configuration of an electrode assembly according to the embodiment.

FIG. 4 is a schematic view illustrating a schematic configuration of a positive electrode tab according to the embodiment.

FIG. 5 is a schematic view illustrating a state where the positive electrode tab according to the embodiment is joined to a current collector.

FIG. 6 is a perspective view illustrating a current collector according to Modification Example 1 of the embodiment.

FIG. 7 is a front view illustrating the current collector according to Modification Example 1 of the embodiment.

FIG. 8 is a front view illustrating a current collector and a positive electrode tab according to Modification Example 2 of the embodiment.

FIG. 9 is a front view illustrating a current collector and a positive electrode tab according to Modification Example 3 of the embodiment.

### MODE FOR CARRYING OUT THE INVENTION

An energy storage device according to one aspect of the present invention is an energy storage device provided with: an electrode assembly formed by winding a plurality of plates; and a case configured to house the electrode assembly. The electrode assembly includes a body including a flat portion and a pair of curved portions sandwiching the flat portion, and a plurality of tabs, each tab formed by stacking a plurality of pieces of plates with the same polarity out of the plurality of plates, the plurality of tabs protruding as a pair from each of both end faces of the body in a winding-axis direction. At least one tab of the plurality of tabs includes a bent portion continuous with the curved portion and a pair of extended portions extended from the bent portion and continuous with the flat portion.

According to this, at least one tab includes the bent portion continuous with the curved portion and the pair of extended portions extended from the bent portion, so that the strength of the entire tab is enhanced by the bent portion. Accordingly, even when the electrode assembly vibrates within the case due to being subjected to an impact or the like, the tab including the bent portion can absorb the movement of the electrode assembly. Therefore, it is possible to prevent damage to the electrode assembly.

The energy storage device may include a plurality of current collectors, each current collector joined to one of the plurality of tabs, and at least one of the pair of extended portions may be joined to the current collector.

According to this, at least one of the pair of extended portions is joined to the current collector, and hence the tab and the current collector can be stably joined to each other even when compared to an instance in which the bent portion and the current collector are joined to each other. Thereby, the tab and the current collector can be firmly joined to each other, and the current collector can restrict the movement of the electrode assembly. Therefore, it is possible to further prevent damage to the electrode assembly.

The pair of extended portions may be joined to the current collector while a plurality of pieces of the plate forming the extended portions are bundled together.

According to this, the pair of extended portions is joined to the current collector while the plurality of pieces of the plate forming the pair of extended portions are bundled together, thereby enabling the entire tab to be closed annularly. Thereby, the strength of the entire tab is further enhanced, and the movement of the electrode assembly can be absorbed more reliably. Therefore, it is possible to further prevent damage to the electrode assembly.

In a state before the joining to the current collector, both ends of each of the plurality of pieces forming the pair of extended portions of the tab may be arranged gradually more forward when moving from one piece at an innermost periphery toward an outer periphery.

According to this, both ends of each of the plurality of pieces forming the pair of extended portions of the tab are arranged gradually more forward when moving from one piece at the innermost periphery toward the outer periphery, so that when the pair of extended portions is gathered at the middle and bundled together, the plurality of pieces can be gathered easily. As a result, workability at the time of bundling the pair of extended portions is improved, and stability during joining can also be improved. When the stability during joining is improved, the overall strength of the tab after joining is also enhanced, and hence the movement of the electrode assembly can be absorbed more reliably. Therefore, it is possible to further prevent damage to the electrode assembly.

A positive electrode tab and a negative electrode tab may be provided as the pair of tabs on each of both end faces of the body.

According to this, in the electrode assembly where the positive electrode tab and the negative electrode tab are provided on each of both end faces of the body, the strength of each tab is also enhanced, thereby making it possible to prevent damage to the electrode assembly.

Of the both end faces of the body, the positive electrode tab and the negative electrode tab provided on one end face and the positive electrode tab and the negative electrode tab provided on an other end face may be arranged in an inverted manner.

According to this, in the body of the electrode assembly, the positive electrode tab and the negative electrode tab formed on one end face of the electrode assembly and the positive electrode tab and the negative electrode tab formed on an other end face of the electrode assembly are arranged in an inverted manner, whereby it is possible to reduce a resistance of the electrode assembly during electrical charge-discharge. This is suitable for an electrode assembly that is long in the winding-axis direction and tends to have high resistance.

Hereinafter, an energy storage device according to an embodiment of the present invention (including its modification examples) will be described with reference to the drawings. Note that any of the embodiment and its modifications described below is a comprehensive or specific example. Numeral values, shapes, materials, components, placement positions and connection forms of the components, manufacturing steps, a sequence of the manufacturing steps, and the like shown in the following embodiment are only examples and are not intended to limit the present invention. In the drawings, dimensions and the like are not illustrated strictly. In the drawings, the same or similar components are denoted by the same reference numerals.

In the following description and drawings, a direction along the winding axis of an electrode assembly, an extending direction of the electrode assembly, or an opposing direction of short side surfaces of a case is defined as the X-axis direction. An opposing direction of long side surfaces of the case or a thickness direction of the case is defined as the Y-axis direction. A direction in which a bottom surface of a case body of the case and a top surface of a lid are aligned or a vertical direction is defined as the Z-axis direction. The X-axis direction, the Y-axis direction, and the Z-axis direction are direction intersecting (orthogonal in the present embodiment) each other. It is conceivable that the Z-axis direction may not be the vertical direction depending on the use aspect, but for convenience of description, a description will be given below with the Z-axis direction as the vertical direction.

In the following description, an X-axis positive direction indicates an arrow direction of the X-axis, and an X-axis negative direction indicates a direction opposite to the X-axis positive direction. The same applies to the Y-axis direction and the Z-axis direction. Further, expressions indicating relative directions or postures, such as parallel and orthogonal, strictly include instances in which the directions or postures are not the same. For example, two directions being orthogonal to each other not only means that the two directions are completely orthogonal to each other but also means that the two directions are substantially orthogonal to each other, that is, the two directions include a difference of, for example, about several percent.

### EMBODIMENT

### 1. General Description of Energy Storage Device

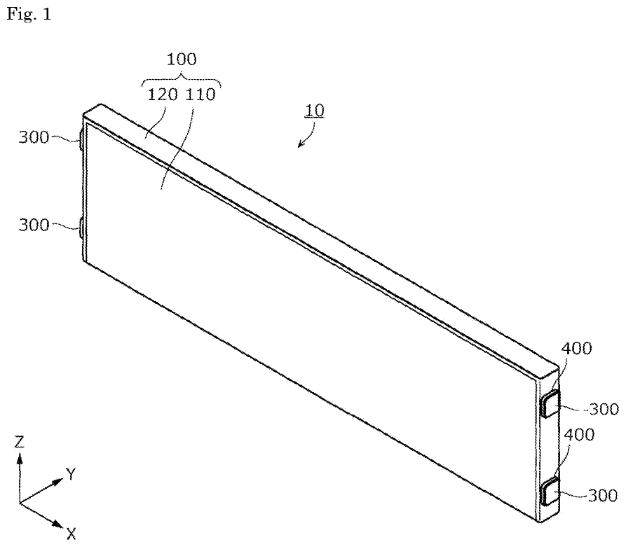

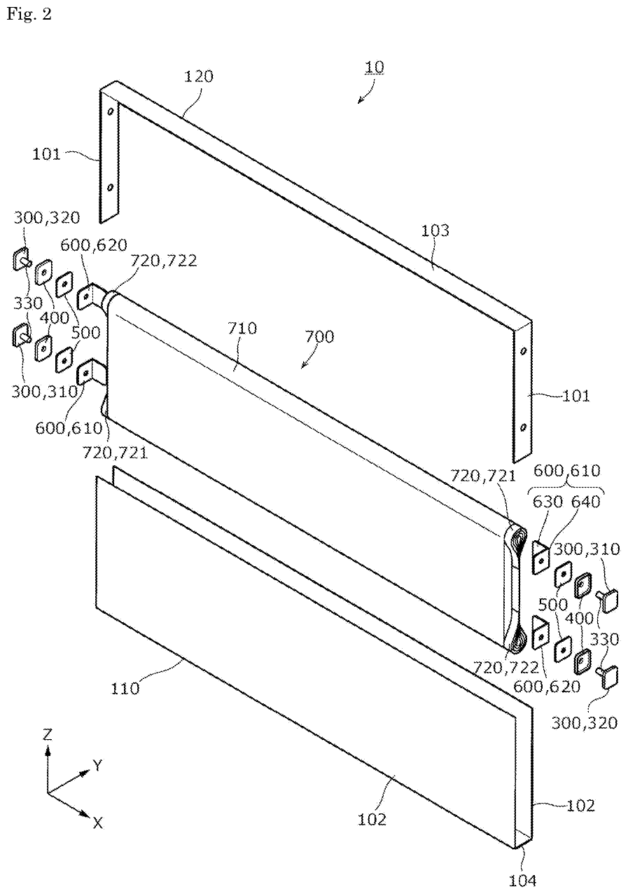

First, a general description of an energy storage device 10 in the present embodiment will be given with reference to FIGS. 1 and 2. FIG. 1 is a perspective view illustrating the external appearance of the energy storage device 10 according to the present embodiment. FIG. 2 is an exploded perspective view illustrating respective components of the energy storage device 10 according to the present embodiment in an exploded state.

The energy storage device 10 is a secondary battery (battery cell) capable of storing and releasing electricity and is specifically a nonaqueous electrolyte secondary battery such as a lithium ion secondary battery. The energy storage device 10 is used as a battery or the like for driving or starting an engine of a moving body such as an automobile, a motorcycle, a watercraft, a ship, a snowmobile, an agricultural machine, a construction machine, or a railway vehicle for electric railways. Examples of the automobile include an electric vehicle (EV), a hybrid electric vehicle (HEV), a plug-in hybrid electric vehicle (PHEV), and a gasoline vehicle. Examples of the railway vehicle for electric railways include a train, a monorail, a linear motor car, and a hybrid train provided with both a diesel engine and an electric motor. The energy storage device 10 can also be used as a stationary battery or the like used for home use, business use, or the like.

The energy storage device 10 is not limited to a nonaqueous electrolyte secondary battery, but may be a secondary battery except for the nonaqueous electrolyte secondary battery, or a capacitor. The energy storage device 10 may not be a secondary battery but may be a primary battery that can use stored electricity without being charged with electricity by a user. The energy storage device 10 may be a pouch-type energy storage device. In the present embodiment, the energy storage device 10 having a flat rectangular parallelepiped shape (prismatic shape) is illustrated. However, the shape of the energy storage device 10 is not limited to the rectangular parallelepiped shape but may be a polygonal columnar shape, a long columnar shape, an elliptical columnar shape, a columnar shape, or the like except for the rectangular parallelepiped shape.

As illustrated in FIG. 1 and FIG. 2, the energy storage device 10 includes a case 100, two pairs of electrode terminals 300, and two pairs of outer gaskets 400. Two pairs of inner gaskets 500, two pairs of current collectors 600, and an electrode assembly 700 are housed in the case 100. Specifically, a pair of (positive electrode side and negative electrode side) members is arranged on one end face of the case 100 in the X-axis positive direction, and the remaining pair of (positive electrode side and negative electrode side) members is arranged on an other end face of the case 100 in the X-axis negative direction. More specifically, on one end face of the case 100 in the X-axis positive direction, each member on the positive electrode side is disposed in the Z-axis positive direction, and each member on the negative electrode side is disposed in the Z-axis negative direction. On the other end face of the case 100 in the X-axis negative direction, each member on the negative electrode side is disposed in the Z-axis positive direction, and each member on the positive electrode side is disposed in the Z-axis negative direction. That is, between one end face and the other end face of the case 100, the respective members on the positive electrode side and the respective members on the negative electrode side are arranged in an inverted (vertically inverted) manner as viewed from the direction along the winding axis (as viewed in the X-axis direction).

The case 100 is filled with an electrolyte solution (nonaqueous electrolyte), which is not illustrated. The type of the electrolyte solution is not particularly limited as long as the electrolyte solution does not impair the performance of the energy storage device 10, and various electrolyte solutions can be selected. In addition to the above constituent elements, a spacer disposed on the lateral side, the upper side, the lower side, or the like of the electrode assembly 700, an insulating film enclosing the electrode assembly 700 and the like, or some other component may be disposed.

The case 100 is a rectangular parallelepiped (prismatic or box-shaped) case long in the X-axis direction. In the case 100, both end faces facing each other in the X-axis direction are short side surfaces 101, and both end faces facing each other in the Y-axis direction are long side surfaces 102. The pair of short side surfaces 101 is one end face and the other end face in the X-axis direction where each member on the positive electrode side and each member on the negative electrode side described above are provided. Further, in the case 100, of both end faces facing each other in the Z-axis direction, the end face in the Z-axis positive direction is a top surface 103, and the end face in the Z-axis negative direction is a bottom surface 104.

The case 100 includes a case body 110 and a lid 120, and the case body 110 and the lid 120 are assembled to form a rectangular parallelepiped shape. The case body 110 includes the pair of long side surfaces 102 and the bottom surface 104. The lid 120 includes the pair of short side surfaces 101 and the top surface 103.

Specifically, the case body 110 is a substantially U-shaped sheet metal with its upper side open as viewed in the X-axis direction. The case body 110 includes flat and rectangular long sidewalls forming the pair of long side surfaces 102 at both ends in the Y-axis direction, and includes a flat and rectangular bottom wall forming the bottom surface 104 at the end in the Z-axis negative direction.

The lid 120 is a substantially U-shaped sheet metal with its lower side open as viewed in the Y-axis direction. The lid 120 includes flat and rectangular short sidewalls forming the pair of short side surfaces 101 at both ends in the X-axis direction, and includes a flat and rectangular top wall forming the top surface 103 at the end in the Z-axis positive direction.

With such a configuration, the case 100 has a structure in which, after the housing of the electrode assembly 700 and the like into the case body 110, the case body 110 and the lid 120 are joined by welding or the like to seal the inside. The material of the case 100 (case body 110 and lid 120) is not particularly limited but is preferably weldable metal such as stainless steel, aluminum, an aluminum alloy, iron, or a plated steel plate.

Although not illustrated, an electrolyte solution filling portion and a gas release valve are formed in the lid 120. The gas release valve is a safety valve that releases pressure inside the case 100 when the pressure increases excessively. The electrolyte solution filling portion is a part for filling the inside of the case 100 with an electrolyte solution at the time of manufacturing the energy storage device 10.

The electrode terminals 300 are terminal members (positive electrode terminal 310 and negative electrode terminal 320) electrically connected to the electrode assembly 700 through the current collector 600. That is, the electrode terminal 300 is a metal member for introducing the electricity stored in the electrode assembly 700 to the external space of the energy storage device 10 and for introducing the electricity into the internal space of the energy storage device 10 in order to store the electricity in the electrode assembly 700. The material of the electrode terminal 300 is not particularly limited, but the electrode terminal 300s (positive electrode terminal 310 and negative electrode terminal 320) are formed of a conductive member such as aluminum, an aluminum alloy, copper, or a copper alloy. The electrode terminal 300 is connected (joined) to the current collector 600 by caulking, welding, or the like and is attached to the lid 120. In the present embodiment, the electrode terminal 300 is provided with the shaft 330, and the shaft 330 is connected (joined) to the current collector 600 by being caulked while penetrating the outer gasket 400, the inner gasket 500, and the current collector 600.

The current collectors 600 are conductive current collecting members (positive current collector 610 and negative current collector 620) that are arranged as a pair on each side of the electrode assembly 700 in the X-axis direction. The current collector 600 is connected (joined) to the electrode assembly 700 and the electrode terminal 300, and electrically connects the electrode assembly 700 and the electrode terminal 300. Specifically, the current collector 600 integrally includes a first connection 630 that is connected (joined) to a tab 720 of the electrode assembly 700 to be described later by welding, caulking, or the like and a second connection 640 that is connected (joined) to the electrode terminal 300 by caulking, welding, or the like and is fixed to the lid 120 as described above. Each of the first connection 630 and the second connection 640 is a flat part and is formed by bending one sheet metal. The material of the current collector 600 is not particularly limited, but the positive current collector 610 is formed of a conductive member such as aluminum or an aluminum alloy, similarly to a positive electrode substrate 741 of the electrode assembly 700 to be described later, and the negative current collector 620 is formed of a conductive member such as copper or a copper alloy, similarly to a negative electrode substrate 751 of the electrode assembly 700 to be described later.

The outer gasket 400 is a plate-shaped rectangular insulating sealing member that is disposed between the lid 120 of the case 100 and the electrode terminal 300 and insulates and seals between the lid 120 and the electrode terminal 300. The inner gasket 500 is a plate-shaped rectangular insulating sealing member that is disposed between the lid 120 and the current collector 600 and insulates and seals between the lid 120 and the current collector 600. The outer gasket 400 and the inner gasket 500 are formed of, for example, a resin having electrical insulation properties such as polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), an ABS resin, or a composite material thereof.

The electrode assembly 700 is an energy storage element (power generating element) formed by winding plates and capable of storing electricity. The electrode assembly 700 has a long shape extending in the X-axis direction and has an oval shape as viewed in the X-axis direction. The electrode assembly 700 has a shape extended in the X-axis direction with a length of, for example, 300 mm or more, specifically, about 500 mm to 1500 mm. Thus, the electrode assembly 700 has a length in the X-axis direction greater than a length in the Z-axis direction. The electrode assembly 700 includes a body 710 and a plurality of tabs 720 protruding from the body 710, and the tab 720 is connected (joined) to the current collector 600 as described above. The plurality of tabs 720 protrude as a pair from each of both end faces of the body 710 in the X-axis direction. For example, on one end face of the body 710 in the X-axis positive direction, a positive electrode tab 721 is provided at the end in the Z-axis positive direction, and a negative electrode tab 722 is provided at the end in the Z-axis negative direction. On the other hand, on the other end face of the body 710 in the X-axis negative direction, the negative electrode tab 722 is provided at the end in the Z-axis positive direction, and the positive electrode tab 721 is provided at the end in the Z-axis negative direction. That is, between one end face and the other end face of the body 710, the positive electrode tabs 721 and the negative electrode tabs 722 are arranged in an inverted (vertically inverted) manner as viewed from the direction along the winding axis (as viewed in the X-axis direction). Such a configuration of the electrode assembly 700 will be described in detail below.

### 2 Description of Configuration of Electrode Assembly 700

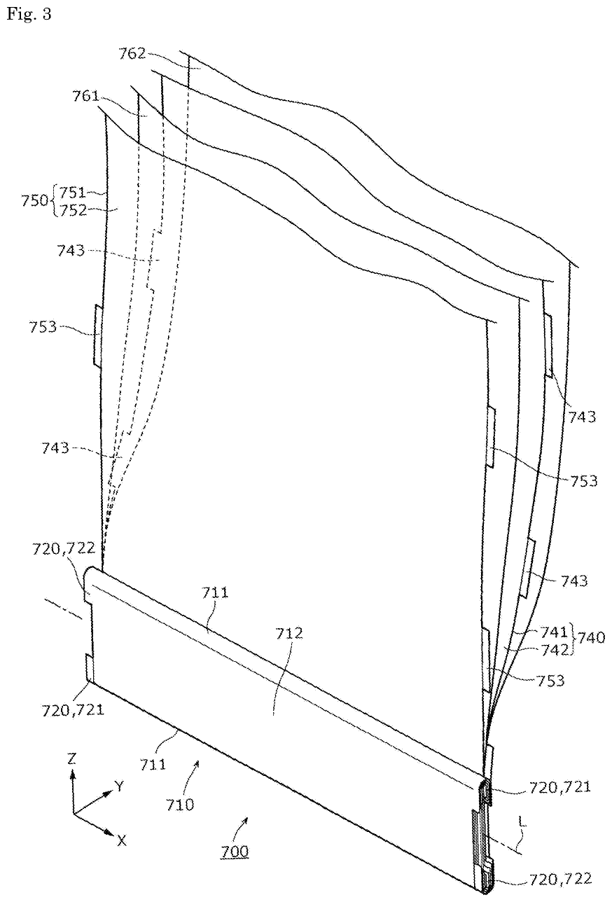

FIG. 3 is a perspective view illustrating the configuration of the electrode assembly 700 according to the present embodiment. Specifically, FIG. 3 illustrates the configuration of the electrode assembly 700 with the winding of plates in a partially unfolded state.

### [2.1 General Description of Electrode Assembly]

As illustrated in FIG. 3, the electrode assembly 700 includes a positive electrode plate 740, a negative electrode plate 750, and separators 761, 762.

The positive electrode plate 740 is an electrode plate in which a positive active material layer 742 is formed on a surface of a positive electrode substrate 741 that is a long strip-shaped metal foil made of aluminum, an aluminum alloy, or the like. The negative electrode plate 750 is an electrode plate in which a negative active material layer 752 is formed on a surface of a negative electrode substrate 751 that is a long strip-shaped metal foil made of copper, a copper alloy, or the like. As the positive electrode substrate 741 and the negative electrode substrate 751, any known materials such as nickel, iron, stainless steel, titanium, fired carbon, a conductive polymer, a conductive glass, or an Al—Cd alloy can be appropriately used as long as the materials are stable against oxidation-reduction reaction during electrical charge-discharge. As the positive active material used for the positive active material layer 742 and the negative active material used for the negative active material layer 752, known materials can be appropriately used as long as the materials are a positive active material and a negative active material capable of occluding and releasing lithium ions.

As the positive active material, it is possible to use a polyanion compound such as LiMPO₄, LiMSiO₄, or LiMBO₃ (M represents one or more transition metal elements selected from Fe, Ni, Mn, Co, and the like.), lithium titanate, a spinel-type lithium manganese oxide such as LiMn₂O₄ or LiMn_{1.5}Ni_{0.5}O₄, a lithium transition metal oxide such as LiMO₂ (M represents one or more transition metal elements selected from Fe, Ni, Mn, Co, and the like.), or the like. Examples of the negative active material include lithium metal, a lithium alloy (lithium metal-containing alloys such as lithium-silicon, lithium-aluminum, lithium-lead, lithium-tin, lithium-aluminum-tin, lithium-gallium, and Wood's alloy), an alloy capable of occluding and releasing lithium, a carbon material (e.g., graphite, non-graphitizable carbon, graphitizable carbon, low-temperature calcined carbon, amorphous carbon, etc.), a silicon oxide, a metal oxide, a lithium metal oxide (Li₄Ti₅O₁₂, etc.), a polyphosphoric acid compound, and a compound of a transition metal and a group 14 to 16 element, such as Co₃O₄ and Fe₂P, which is generally referred to as a conversion negative electrode.

The separators 761, 762 are microporous sheets made of resin. As the material of the separators 761, 762, any known material can be appropriately used as long as the performance of the energy storage device 10 is not impaired. For example, as the separators 761, 762, it is possible to use a woven fabric insoluble in an organic solvent, a nonwoven fabric, a synthetic resin microporous membrane made of a polyolefin resin such as polyethylene, or the like.

The electrode assembly 700 is formed by alternately stacking and winding the positive electrode plate 740, the negative electrode plate 750, and the separators 761, 762. That is, the electrode assembly 700 is formed by stacking and winding the negative electrode plate 750, the separator 761, the positive electrode plate 740, and the separator 762 in this order. In the present embodiment, the electrode assembly 700 is a winding-type (so-called vertical winding-type) electrode assembly formed by winding the positive electrode plate 740, the negative electrode plate 750, and the like around a winding axis L extending in the X-axis direction. The winding axis L is a virtual axis that is a central shaft when the positive electrode plate 740, the negative electrode plate 750, and the like are wound, and in the present embodiment, the winding axis L is a straight line that passes through the center of the electrode assembly 700 and is parallel to the X-axis direction.

On both end edges of the positive electrode plate 740 in the winding-axis direction, a plurality of protruding pieces 743 protruding outward are arranged in a staggered manner in the plan view of the positive electrode plate 740. Similarly, at both end edges of the negative electrode plate 750 in the winding-axis direction, a plurality of protruding pieces 753 protruding outward are arranged in a staggered manner in the plan view of the negative electrode plate 750. In the state after stacking, each protruding piece 743 of the positive electrode plate 740 and each protruding piece 753 of the negative electrode plate 750 are alternately and repeatedly aligned in the longitudinal direction of the positive electrode plate 740 and the negative electrode plate 750, respectively. Each of the protruding pieces 743, 753 is a portion (active material layer non-formed portion) where the active material layer containing the active material is not formed and the substrate layer is exposed.

When the positive electrode plate 740 and the negative electrode plate 750 and the separators 761, 762 are wound, the protruding pieces 743 of the positive electrode plate 740 are superimposed and the protruding pieces 753 of the negative electrode plate 750 are superimposed at one end face and the other end face of the body 710, respectively. A portion where the protruding pieces 743 of the positive electrode plate 740 are superimposed on each other is the positive electrode tab 721. That is, the positive electrode tab 721 is a part formed by stacking the plurality of pieces (protruding pieces 743) of one plate (positive electrode plate 740) having the same polarity out of the plurality of plates (positive electrode plate 740 and negative electrode plate 750).

Similarly, a portion where the protruding pieces 753 of the negative electrode plate 750 superimposed on each other is the negative electrode tab 722. That is, the negative electrode tab 722 is a part formed by stacking the plurality of pieces (protruding pieces 753) of one plate (negative electrode plate 750) having the same polarity out of the plurality of plates (positive electrode plate 740 and negative electrode plate 750).

That is, the electrode assembly 700 includes: the body 710 that forms the body of the electrode assembly 700; and the plurality of tabs 720 (positive electrode tab 721 and negative electrode tab 722) that protrude as a pair from each of both end faces of the body 710 in the X-axis direction, respectively.

The body 710 is a long columnar part (active material layer formed portion) formed by winding the portions of the positive electrode plate 740 and the negative electrode plate 750, in which the positive active material layer 742 and the negative active material layer 752 are formed (coated), and the separators 761, 762. Thereby, the body 710 includes a pair of curved portions 711 on both sides in the Z-axis direction and includes flat portions 712, which are flat as a whole, between the pair of curved portions 711. It can be said that the pair of curved portions 711 are located to sandwich the flat portion 712 in the Z-axis direction.

The curved portions 711 are curved parts curved in a semicircular arc shape to protrude in the Z-axis direction as viewed in the X-axis direction and extended in the X-axis direction, and are arranged to face the bottom wall of the case body 110 and the top wall of the lid 120. That is, the pair of curved portions 711 are parts curved to protrude on both sides in the Z-axis direction from the flat portion 712 toward the bottom wall of the case body 110 and the top wall of the lid 120 as viewed in the X-axis direction. The flat portion 712 is a rectangular and flat part connecting the ends of the pair of curved portions 711 to each other and extending parallel to the XZ plane directed in the Y-axis direction, and is disposed to face the long sidewalls on both sides in the Y-axis direction of the case body 110. Note that the curved shape of the curved portion 711 is not limited to the semicircular arc shape, but may be a part of an elliptical shape or the like, and may be curved in any manner. The outer surface of the flat portion 712 facing the Y-axis direction is not limited to a flat surface, and the outer surface may be slightly recessed or slightly bulged.

### [2.2 Description of Tab]

Next, details of the tab 720 will be described. Since the basic structure of each tab 720 is the same, a description will be given mainly of the positive electrode tab 721 provided on one end face of the body 710 in the X-axis positive direction, and the description of the other tabs 720 will be omitted.

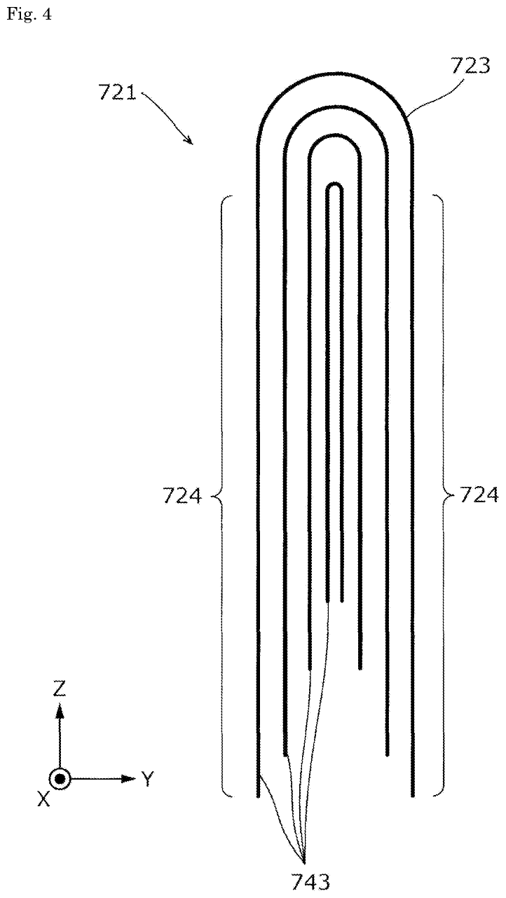

FIG. 4 is a schematic view illustrating a schematic configuration of the positive electrode tab 721 according to the embodiment. In FIG. 4, the positive electrode tab 721 before being joined to the current collector 600 is illustrated as viewed in the X-axis direction. In FIG. 4, the plurality of protruding pieces 743 constructing the positive electrode tab 721 are simplified in number and illustrated.

As illustrated in FIGS. 3 and 4, the positive electrode tab 721 includes a bent portion 723 and a pair of extended portions 724. The bent portion 723 is a part continuous with the curved portion 711 of the body 710. Hence the bent portion 723 has a curved shape corresponding to the curved portion 711. The pair of extended portions 724 are parts extended from both ends of the bent portion 723 and continuous with the flat portion 712 of the body 710. Hence the pair of extended portions 724 is substantially flat in a state before being joined to the current collector 600. The curved bent portion 723 has higher structural strength than each of the flat extended portions 724.

Here, as illustrated in FIG. 4, in a state before the joining to the current collector 600, both ends of each of the plurality of protruding pieces 743 forming the pair of extended portions 724 are arranged gradually more forward (in FIG. 4, the Z-axis negative direction) when moving from the protruding piece 743 at the innermost periphery toward the outer periphery. In this context, forward of the plurality of protruding pieces 743 refers to a direction away from the bent portion 723 as well as a direction from one side of the pair of curved portions 711 toward the other side of the pair of curved portions 711. That is, of the plurality of protruding pieces 743 forming the pair of extended portions 724, both ends of the protruding piece 743 located on the innermost side are at the furthest back position. Both ends of each of the protruding pieces 743 protrude gradually more forward when moving from the protruding piece 743 on the innermost side toward the protruding piece 743 outward, and both ends of the protruding piece 743 located on the outermost side are at the most forwardly protruded position.

Next, a state after the positive electrode tab 721 is joined to the current collector 600 will be described. FIG. 5 is a schematic view illustrating a state where the positive electrode tab 721 according to the embodiment is joined to the current collector 600. Specifically, FIG. 5 is a diagram corresponding to FIG. 4.

As illustrated in FIG. 5, before being joined to the current collector 600, the plurality of protruding pieces 743 forming the pair of extended portions 724 are gathered at the middle (the middle in the arrangement direction of the plurality of protruding pieces 743) and bundled together. As described above, since both ends of each of the plurality of protruding pieces 743 forming the pair of extended portions 724 are arranged gradually more forward when moving from the protruding piece 743 at the innermost periphery toward the outer periphery, the plurality of protruding pieces 743 can be easily gathered at the middle and bundled together. By this bundling, the bent portion 723 and the pair of extended portions 724 are annularly closed in the entire positive electrode tab 721. That is, the entire positive electrode tab 721 is reinforced by the bent portion 723, thus preventing damage to the positive electrode tab 721. FIG. 5 illustrates an instance in which the innermost protruding piece 743 of the protruding pieces 743 forming the pair of extended portions 724 is not bundled by the other protruding pieces 743. Although the strength of the entire positive electrode tab 721 can also be enhanced in this state, when higher strength improvement is desired, all the protruding pieces 743 may be bundled together. After bundling, the first connection 630 of the current collector 600 is joined (welded) to the pair of extended portions 724.

After the pair of extended portions 724 and the current collector 600 are joined to each other, the state of each protruding piece 743 before joining can also be determined by observing each protruding piece 743 in the pair of extended portions 724. For example, as illustrated in FIG. 5, it can be determined after joining that the state is similar before joining because both ends of each of the plurality of protruding pieces 743 forming the pair of extended portions 724 are arranged gradually more forward when moving from the protruding piece 743 at the innermost periphery toward the outer periphery.

### 3 Description of Effects

As described above, the energy storage device 10 according to the embodiment of the present invention includes the electrode assembly 700 formed by winding the plurality of plates (positive electrode plates 740 and negative electrode plates 750), and the case 100 that houses the electrode assembly 700. The electrode assembly 700 includes: the body 710 including the flat portion 712 and the pair of curved portions 711 sandwiching the flat portion 712; and the plurality of tabs 720, each tab formed by stacking the plurality of pieces (protruding pieces 743, 753) of the plates having the same polarity out of the plurality of plates, and protrude as a pair from both end faces of the body 710 in the winding-axis direction. At least one tab (positive electrode tab 721) of the plurality of tabs 720 includes the bent portion 723 continuous with the curved portion 711, and the pair of extended portions 724 extended from the bent portion 723 and continuous with the flat portion 712.

According to this, the positive electrode tab 721 includes the bent portion 723 continuous with the curved portion 711 and the pair of extended portions 724 extended from the bent portion 723, so that the bent portion 723 can enhance the strength of the entire positive electrode tab 721. Accordingly, even when the electrode assembly 700 vibrates within the case 100 due to an impact or the like, the positive electrode tab 721 including the bent portion 723 can absorb the movement of the electrode assembly 700. It is thus possible to prevent damage to the electrode assembly 700.

The energy storage device 10 includes the plurality of current collectors 600, each current collector joined to one of the plurality of tabs 720. At least one of the pair of extended portions 724 is joined to the current collector 600.

According to this, at least one of the pair of extended portions 724 is joined to the current collector 600, and hence the tab 720 and the current collector 600 can be stably joined to each other even when compared to an instance in which the bent portion 723 and the current collector 600 are joined to each other. Thereby, the tab 720 and the current collector 600 can be firmly joined to each other, and the current collector 600 can restrict the movement of the electrode assembly 700. Therefore, it is possible to further prevent damage to the electrode assembly 700.

The pair of extended portions 724 is joined to the current collector 600 while the plurality of pieces (protruding pieces 743) of the plate forming the extended portions 724 are bundled together.

According to this, the pair of extended portions 724 is joined to the current collector 600 while the plurality of protruding pieces 743 forming the pair of extended portions 724 are bundled together, thereby enabling the entire positive electrode tab 721 to be closed annularly. Thereby, the strength of the entire positive electrode tab 721 is further enhanced, and the movement of the electrode assembly 700 can be absorbed more reliably. Therefore, it is possible to further prevent damage to the electrode assembly 700.

In a state before the joining to the current collector 600, both ends of each of the plurality of pieces (protruding pieces 743) forming the pair of extended portions 724 of the tab (positive electrode tab 721) are arranged gradually more forward when moving from one piece at the innermost periphery toward the outer periphery.

According to this, both ends of each of the plurality of protruding pieces 743 forming the pair of extended portions 724 of the positive electrode tab 721 are arranged gradually more forward when moving from the protruding piece 743 at the innermost periphery toward the outer periphery, so that when the pair of extended portions are gathered at the middle and bundled together, the pair of extended portions 724 can be gathered easily. As a result, workability at the time of bundling the pair of extended portions 724 is improved, and stability during joining can also be improved. When the stability during joining is improved, the entire strength of the positive electrode tab 721 after joining is also enhanced, and hence the movement of the electrode assembly 700 can be absorbed more reliably. Therefore, it is possible to further prevent damage to the electrode assembly 700.

Here, as a comparative example, an electrode assembly in which a pair of tabs is provided only on one end face of a body is assumed. In this instance, the other end face of the body is planar as a whole. When the electrode assembly moves, each tab absorbs the movement of the electrode assembly on one end face side of the body, and absorbs the movement of the electrode assembly on a large plane on the other end face side of the body. Accordingly, on the other end face side of the body, the stress at the time of absorption is dispersed, and the load on the electrode assembly is reduced.

On the other hand, as in the present embodiment, in the electrode assembly 700 in which the positive electrode tab 721 and the negative electrode tab 722 are provided on each of both end faces of the body 710, the positive electrode tab 721 and the negative electrode tab 722 absorb the movement of the electrode assembly 700 on each of both end faces of the body 710. That is, the positive electrode tab 721 and the negative electrode tab 722 absorb the movement of the electrode assembly 700 also on the other end face side of the body 710, and hence large stress acts on the positive electrode tab 721 and the negative electrode tab 722 as compared to the comparative example, causing damage to these tabs. In the present embodiment, due to the enhanced strength of each of the tabs 720, it is also possible to prevent damage to the electrode assembly 700 in the electrode assembly 700 in which the positive electrode tab 721 and the negative electrode tab 722 are provided on each of both end faces of the body 710.

Of both end faces of the body 710, the positive electrode tab 721 and the negative electrode tab 722 provided on one end face and the positive electrode tab 721 and the negative electrode tab 722 provided on the other end face are arranged in an inverted manner.

The inventor of the present application has found that when the positive electrode tabs 721 and the negative electrode tabs 722 are inverted between one end face and the other end face of the body 710 of the electrode assembly 700, the resistance of the electrode assembly 700 during electrical charge-discharge is reduced compared to when the positive electrode tab and the negative electrode tab are not inverted. That is, when the positive electrode tab 721 and the negative electrode tab 722 provided on one end face and the positive electrode tab 721 and the negative electrode tab 722 provided on the other end face are arranged in an inverted manner in the body 710 of the electrode assembly 700, it is possible to reduce the resistance of the electrode assembly 700 during electrical charge-discharge. This is suitable for the electrode assembly 700 that is long in the winding-axis direction and tends to have high resistance.

### 4 Description of Modification Examples

Each modification example of the above embodiment will be described below. In the following description, the same portions as those in the above embodiment are denoted by the same reference numerals, and the description thereof may be omitted.

### Modification Example 1

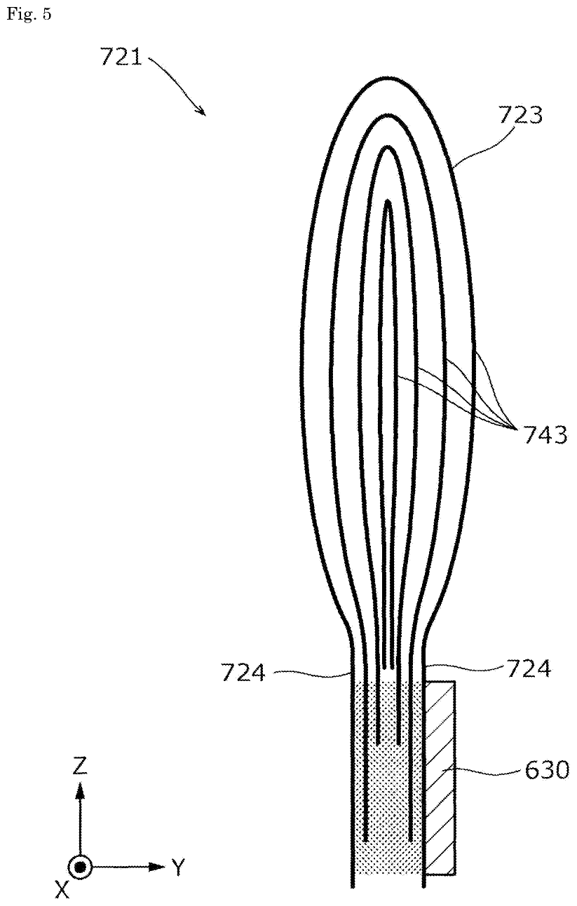

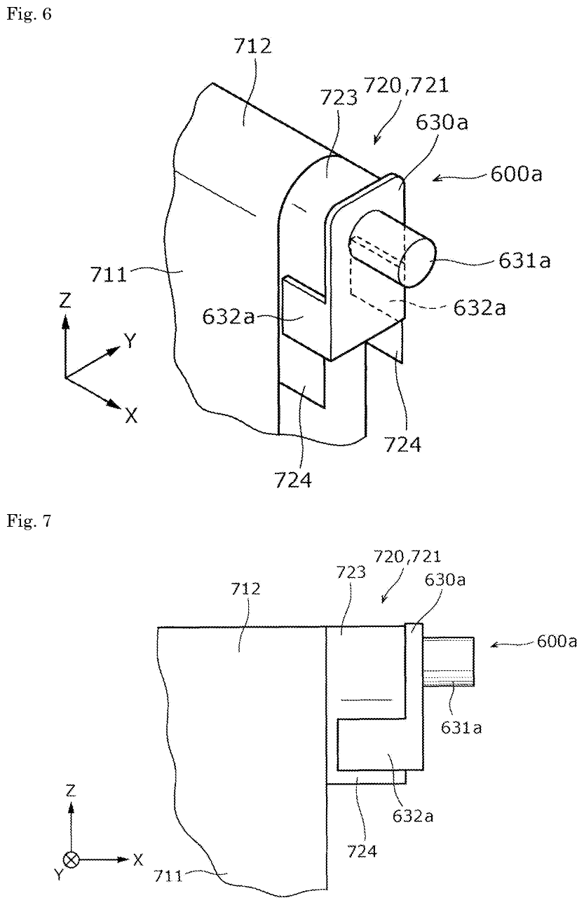

Next, Modification Example 1 of the above embodiment will be described. FIG. 6 is a perspective view illustrating a current collector 600a according to Modification Example 1 of the embodiment. FIG. 7 is a front view illustrating the current collector 600a according to Modification Example 1 of the embodiment.

As illustrated in FIGS. 6 and 7, in the present modification example, the current collector 600a is provided with a swaging shaft 631a. Specifically, the current collector 600a includes a current collector body 630a, a shaft 631a, and a pair of connections 632a.

The current collector body 630a is a flat rectangular part parallel to the YZ plane and long in the Z-axis direction. The shaft 631a protrudes from the main surface of the current collector body 630a in the X-axis positive direction. The main surface of the current collector body 630a in the X-axis negative direction is formed in a planar shape. The shaft 631a is a columnar part extending in the X-axis direction. The shaft 631a is connected (joined) to the electrode terminal by being caulked while penetrating the inner gasket, the outer gasket, and the electrode terminal.

The pair of connections 632a is plate-shaped parts protruding in the X-axis negative direction from a pair of end side portions of the current collector body 630a in the Z-axis negative direction. Specifically, each of the connections 632a is a flat rectangular part parallel to the XZ plane and long in the Z-axis direction. The respective connections 632a are joined (welded) to the respective extended portions 724 of the positive electrode tab 721. In the present modification example, the respective extended portions 724 and the respective connections 632a are joined without bundling the pair of extended portions 724. However, when the pair of extended portions 724 is bundled together, the bundled pair of extended portions 724 may be joined only to one of the pair of connections 632a. In this instance, the other connection 632a may not be provided in the current collector 600a.

At the time of joining the connections 632a and the extended portions 724 to each other, the current collector body 630a is in contact with the end face of the bent portion 723. In this context, the end face of the bent portion 723 refers to the distal end face of the bent portion 723 in a protruding direction (X-axis direction) in which the positive electrode tab 721 protrudes from the body 710. As described above, the bent portion 723 is a part having higher structural strength than the extended portion 724. Since the current collector body 630a is in contact with the end face of the bent portion 723 having a relatively high strength, the movement of the electrode assembly 700 joined to the current collector 600a can be restricted more effectively. Therefore, it is possible to further prevent damage to the electrode assembly 700.

### Modification Example 2

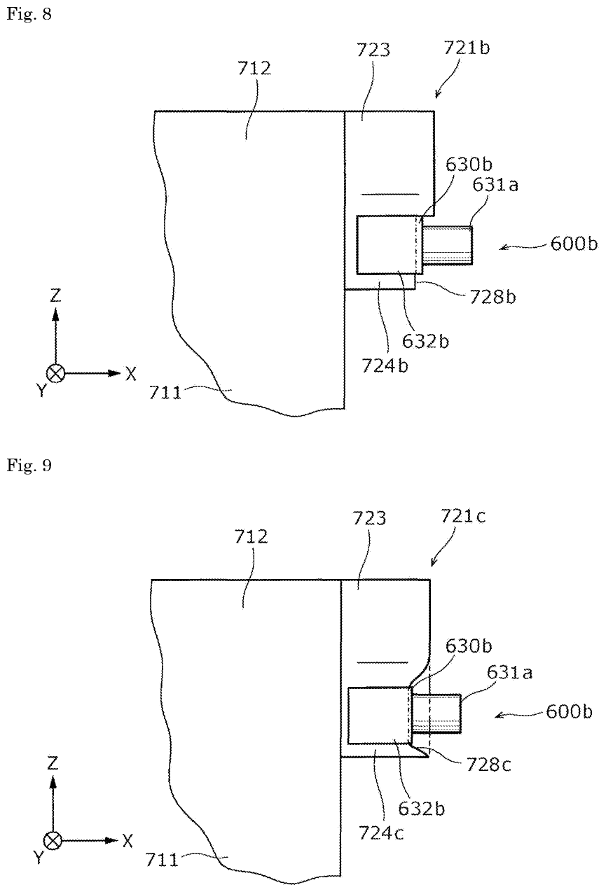

Next, Modification Example 2 of the above embodiment will be described. FIG. 8 is a front view illustrating a current collector 600b and a positive electrode tab 721b according to Modification Example 2 of the embodiment. FIG. 8 is a diagram corresponding to FIG. 7.

The current collector 600b basically has the same configuration as the current collector 600a of Modification Example 1, but is different in that the length of a current collector body 630b in the Z-axis direction is smaller than that of the current collector body 630a. For this reason, the current collector body 630b does not reach the end face of the bent portion 723b even in a state where respective connections 632b are joined to respective extended portions 724b. That is, the current collector body 630b is disposed not to overlap the end face of the bent portion 723b as viewed in the X-axis direction.

On the other hand, in the positive electrode tab 721b, a recess 728b that houses at least a part of the current collector body 630b is formed in each extended portion 724b. The recess 728b is a notch formed at the end of each extended portion 724b in the X-axis positive direction before joining. Since at least a part of the current collector body 630b is housed in the recess 728b, it is possible to reduce the amount of protrusion of the current collector 600b from the positive electrode tab 721b. This can enhance space efficiency within the case 100. By increasing the depth of the recess 728b to be larger than the thickness of the current collector body 630b, the thickness of the current collector body 630b can be entirely housed in the recess 728b. Therefore, the amount of protrusion of the current collector 600b from the positive electrode tab 721b can be further reduced, which is preferable.

### Modification Example 3

Next, Modification Example 3 of the above embodiment will be described. FIG. 9 is a front view illustrating a current collector 600b and a positive electrode tab 721c according to Modification Example 3 of the embodiment. FIG. 9 is a diagram corresponding to FIG. 8.

In Modification Example 2, the instance in which the recess 728b is a notch formed in each extended portion 724b before joining has been exemplified. In Modification Example 3, an instance in which a recess 728c is formed in each extended portion 724c by a joining operation will be described. In FIG. 9, the end face of each extended portion 724c before joining is indicated by a dotted-dash line. Before joining, the end face of each extended portion 724c is flush with the end face of the bent portion 723.

During the joining operation, the current collector body 630b of the current collector 600b is pressed against the end face of each of the extended portions 724c, whereby the end face of each of the extended portions 724c is deformed into a recessed shape to form a recess 728c. At least a part of the current collector body 630b is housed in the recess 728c, so that it is possible to reduce the amount of protrusion of the current collector 600b from the positive electrode tab 721c. This can enhance space efficiency within the case 100.

### Other Modification Examples

The energy storage device according to the embodiment of the present invention (including its modifications, which applies hereinafter) has been described above, but the present invention is not limited to the above embodiment. The embodiment disclosed herein is an example in all respects, and the scope of the present invention includes all modifications within the meaning and scope equivalent to the claims.

For example, although the instance has been exemplified in the embodiment described above in which each of all the tabs 720 provided in the electrode assembly 700 includes the bent portion and the pair of extended portions, it is sufficient that at least one tab provided in the electrode assembly includes the bent portion and the pair of extended portions. For example, even when only one tab includes the bent portion and the pair of extended portions, the tab can absorb the movement of the electrode assembly to some extent.

In the embodiment described above, the instance has been exemplified in which both ends of each of the plurality of protruding pieces 743 forming the pair of extended portions 724 of the positive electrode tab 721 are arranged gradually more forward when moving from the protruding piece 743 at the innermost periphery toward the outer periphery. Both ends of each of the plurality of protruding pieces that form each extended portion may be located at arbitrary positions. For example, both ends of each of the plurality of protruding pieces that form each extended portion may be flush.

In the embodiment described above, the instance has been exemplified in which, between one end face and the other end face of the body 710 of the electrode assembly 700, the positive electrode tabs 721 and the negative electrode tabs 722 are arranged in an inverted (vertically inverted) manner as viewed in the X-axis direction. However, the positive electrode tabs and the negative electrode tabs may not be inverted.

In the embodiment described above, the instance in which the positive electrode tab 721 and the negative electrode tab 722 are formed on each of both end faces of the body 710 of the electrode assembly 700 has been exemplified. However, the positive electrode tab and the negative electrode tab may be provided only on one of both end faces of the body of the electrode assembly. In this instance, the electrode terminal 300, the current collector 600, the outer gasket 400, and the inner gasket 500 are also provided only on one short side surface 101 of the case 100 corresponding to each of the positive electrode tab and the negative electrode tab.

The scope of the present invention also includes forms constructed by arbitrarily combining the components included in the above embodiment and its modifications.

### INDUSTRIAL APPLICABILITY

The present invention can be applied to an energy storage device such as a lithium ion secondary battery.

### DESCRIPTION OF REFERENCE SIGNS

10: energy storage device
100: case
101: short side surface
102: long side surface
103: top surface
104: bottom surface
110: case body
120: lid
300: electrode terminal
310: positive electrode terminal
320: negative electrode terminal
330, 631a: shaft
400: outer gasket
500: inner gasket
600, 600a, 600b: current collector
610: positive current collector
620: negative current collector
630: first connection
630a, 6430b: current collector body
632a, 632b: connection
640: second connection
700: electrode assembly
710: body
711: curved portion
712: flat portion
720: tab
721, 721b, 721c: positive electrode tab
722: negative electrode tab
723, 723b: bent portion
724, 724b, 724c: extended portion
728b, 728c: recess
740: positive electrode plate
741: positive electrode substrate
742: positive active material
743, 753: protruding piece
750: negative electrode plate
751: negative electrode substrate
752: negative active material layer
761, 762: separator

1. An energy storage device comprising:
an electrode assembly formed by winding a plurality of plates; and
a case configured to house the electrode assembly,
wherein the electrode assembly includes:
a body including a flat portion and a pair of curved portions sandwiching the flat portion; and
a plurality of tabs, each tab formed by stacking a plurality of pieces of plates with the same polarity out of the plurality of plates, the plurality of tabs protruding as a pair from each of both end faces of the body in a winding-axis direction, and
at least one tab of the plurality of tabs includes:
a bent portion continuous with the curved portion; and
a pair of extended portions extended from the bent portion and continuous with the flat portion.

2. The energy storage device according to claim 1, further comprising a plurality of current collectors, each current collector joined to one of the plurality of tabs,
wherein at least one of the pair of extended portions is joined to the current collector.

3. The energy storage device according to claim 2, wherein the pair of extended portions is joined to the current collector while a plurality of pieces of the plate forming the extended portions are bundled together.

4. The energy storage device according to claim 2, wherein in a state before the joining to the current collector, both ends of each of the plurality of pieces forming the pair of extended portions of the tab are arranged gradually more forward when moving from one piece at an innermost periphery toward an outer periphery.

5. The energy storage device claim 1, wherein a positive electrode tab and a negative electrode tab are provided as the pair of tabs on each of both end faces of the body.

6. The energy storage device according to claim 5, wherein, of the both end faces of the body, the positive electrode tab and the negative electrode tab provided on one end face and the positive electrode tab and the negative electrode tab provided on an other end face are arranged in an inverted manner.
